(19) United States
(12) Patent Application Publication
(10) Pub. No.: US 2022/0230335 A1
(43) Pub. Date: Jul. 21, 2022

(54) One-shot high-accuracy geometric modeling of three-dimensional scenes

(71) Applicant: Nicolae Paul Teodorescu, Mission Viejo, CA (US)

(72) Inventor: Nicolae Paul Teodorescu, Mission Viejo, CA (US)

(21) Appl. No.: 17/153,685

(22) Filed: Jan. 20, 2021

(51) Int. Cl. G06T 7/521; G06T 7/73; G01B 11/00

(52) U.S. Cl. CPC G06T 7/521; G06T 2207/10028; G01B 11/002; G06T 7/73

(57) ABSTRACT

A method for providing three-dimensional (3-D) digitization of a scene with increased accuracy, speed and detail detection establishing a bijective association of distinguishable plurality of strips projected onto a 3-D scene.

A 3-D imaging system obtaining frames of 3-D measurements by projecting polygonal formation of linear strips with unrestricted relative motion providing substantially denser sampling of 3-D scene.

This application claims the benefit of Provisional Patent Application No. 62/964,466 filed 2020 Jan. 22.

### CROSS-REFERENCE TO RELATED APPLICATIONS

None.

### FEDERALLY SPONSORED RESEARCH

None.

### SEQUENCE LISTING

None.

### FIELD OF INVENTION

The present invention relates to general field of three-dimensional (3-D) digitization of physical objects and three-dimensional environments using active triangulation, in particular to obtaining 3-D frames of dense measurements in real time at rates suitable but not exclusively for objects in motion.

3-D imaging systems find their use in increasingly diverse applications such as manufacturing, medicine, multi-media, interactive visualization and heritage preservation, to name a few, are areas where obtaining complex geometry and color information is increasingly required. Traditional high cost of scanning systems still prevents adoption of these technologies on large scale. Continuous reduction of cost and increase in performance of components opens venues for introducing cost-effective, easy to use, 3-D optical scanning systems.

This invention presents a high-density, high-speed, simple to operate, triangulating 3-D scanning system capable of obtaining massive amounts of 3-D coordinates in single-shot frames at low costs.

Optical scanning systems based on active triangulation principle measure the distance from sensor to object surface by typically projecting a well defined radiation pattern and acquiring sets of 3-D points representing coordinates from sensor's viewpoint.
To obtain sufficient samples to describe the surface, sensor head is rotated and translated relative to the object, obtaining multiple measurements which are integrated in a common reference frame to reconstruct a model of surface geometry.

The main differences among active triangulation techniques known in the art lie in the type and method of radiation projected onto 3-D scene which is typically designed to facilitate identification of projected features reflected from the scene onto an image sensor for the purpose of computing depth coordinates of illuminated pixels.

In general the outcome is a set of images processed for some type of disparity or displacement map utilized in final step of calculating depth coordinates according to well known methods in the art.

Another difference among active triangulation methods known in the art lie in the number of image sensors utilized. Array of two or more cameras and one or more projectors exists wherein 3-D scene is illuminated by patterns types that facilitates correlation of two or more images.
The problem with multiple image sensors rest in operational complexity as well as end-user cost.

Another active triangulation systems utilize one image sensor and a single projected pattern onto the imaged object, thus enabling reconstruction of depth coordinates form one or more simultaneous images rather than multiple images over a time interval.

Present invention is focused on active triangulation systems to acquire very large amounts of coordinates at each digital frame utilizing one image sensor and a single radiation pattern wherein the system, the object or both may be in relative motion to each other.

Nonetheless many methods have been introduced over the years for 3-D imaging of moving objects, most of which based on the projection of single radiation pattern on the imaged object, enabling reconstruction of depth coordinates from one image rather than multiple images over a time interval.
The very fact that there are a large number of systems capable of obtaining depth coordinates from a single digital image of a scene encoded by structured radiation hints at the underlying problem of lack of sufficiently effective method for 3-D imaging.

### BACKGROUND OF INVENTION

Structured illumination methods that facilitate single-shot 3-D imaging use a structure consisting of spatial and/or spectral coding of a number of features embedded in the projected pattern. In spectral coding pattern features are identified in digital image by their respective pixels chromaticity, which severely limits the class of surfaces applicable to this type of measurement.

Spatial coded patterns contain distinct features identified by comparison with features from reference images stored in computer memory.
A number of one-shot 3-D imaging techniques exists.

U.S. Pat. No. 8,493,496 teaches of a speckle projector where a dot pattern encodes the scene and where scene depth is obtained from analyzing pattern shifts in a digital frame relative to a stored reference image. This simple setup has fundamental limitations: low spatial resolution as encoded features must be distinguishable from in digital frame; high sensitivity to noise because speckle must be larger than at least two camera pixels; low measurement accuracy because windows of many pixels must be analyzed for statistical correlation. Certain objects may exhibit features where strips projection are more suitable to extract local geometry as speckle patterns can create feature round-offs, detail distortions or miss details entirely, which is unsuitable for certain applications. Although depth measurements are obtained from each frame, depth errors due to reference frame scale approximation and dots pinpointing errors add up to the system unsuitability in measurement applications.

U.S. Pat. No. 7,768,656 utilize code words technique to carry out pattern identification by analyzing patterns of pixel configurations to be recognized unambiguously. The robustness of decoding may be adversely impacted by a number of conditions, such as object geometry, texture, local contrast variance, may adversely impact accuracy and therefore imposes restrictions on suitability. A substantial number of pixels have to be analyzed to identify the code words in digital frame and as such the number of coordinates in each 3-D frame is reduced.

U.S. Pat. No. 8,090,194B2 teaches a depth measurement system utilizing a spatially coded bi-dimensional projection pattern having a plurality of distinctive features that need identification and where restrictions are imposed on minimum distance of adjacent epipolar lines which limits scene sampling.

U.S. Pat. No. 8,837,812B2 teaches of utilizing a pattern consisting of an orthogonal grid having strips horizontal and vertical with respect to digital frame, where a number of calculations are performed for each intersection to eliminate ambiguity and identify intersecting strips. Because the technique relies on detecting intersections it imposes a minimum distance between strips and as such on sampling.

Non Patent Literature 1 uses a projected pattern formed of edges and intersection nodes, wherein an active stereo matching technique are utilized to identify nodes captured in digital frames. As such only a sparse sampling of the scene is obtained, and most of the scene is ignored.

U.S. Pat. No. 9,633,439B2 teaches a 3-D reconstruction system where the projected pattern has a wavy lines intersecting each other where only intersection points are identified and depth is calculated just for intersection points, resulting in sparse 3-D coordinates.

### Advantages of the Invention

The method of present invention utilizes a simple, code-free bi-dimensional pattern, comprising one feature type having no epipolar restrictions, which simplifies feature detection and increase density and accuracy of depth measurements. The method of present invention is suitable for dynamic scenes where relative motion exists.

An unexpected advantage of the invention is the ability to discriminate between multiple radiation patterns and as such suitable for acquisition of wider dynamic scenes.

### SUMMARY OF THE INVENTION

A method for obtaining measurement of three-dimensional (3-D) spatial data from a scene comprising:
irradiating the scene by at least one pattern from a projector frame, comprising a plurality of distinguishable rectilinear line segments, wherein said rectilinear segments are topologically interconnected at vertices wherein said vertices are located at coordinates selected randomly within predefined limits, wherein said interconnected said rectilinear line segments give rise to an non-regular reticular lattice comprising a plurality of polygonal eyelets;
capturing a digital image of at least a portion of reflected said reticular lattice reflected from the scene from a different respective location in the scene in the form of interconnected curvilinear segments;
calculating a predetermined number of reference images derived from said pattern in said projector frame, wherein said said predetermined number of reference images are planar homographies of said pattern frame calculated at predetermined depths down projection direction;
locate pixel coordinates of reflected vertices from said scene captured in said digital image;
identify said reflected vertices in said projector frame by effecting correlation computation of each of said reflected vertices and a subset of vertices in said predetermined number of reference images, wherein
   said subset of vertices correspond to a subset of remapped epipolar matches in said at least one pattern in said projector frame;
   said subset of remapped epipolar matches correspond to a predetermined interval of epipolar line in said at least one pattern in said projector frame
   said predetermined interval is selected in accordance with predetermined depth of field;
   correlation result is accumulated over a predetermined neighborhood of each of said subset of vertices;
   effecting correlation computation at said pixel coordinates of said reflected vertices and each of said reference images, wherein said correlation computation is performed over said epipolar search segment;
   identify matching vertices pairs from neighborhood having best said correlation accumulated score
identifying said curvilinear segments adjacent to said reflecting vertices in said digital image from said pattern topology;
calculating 3-D spatial coordinates by triangulating said rectilinear segments and illuminated pixels of said curvilinear segments in said digital image;

An apparatus for obtaining 3-D spatial coordinates from a scene comprising:
a radiation pattern having a plurality of predefined rectilinear segments topologically interconnected at a plurality of vertices located at predetermined locations, forming a reticular lattice of polygonal eyelets;
a projector for projecting said radiation pattern on said scene,
an imaging device for capturing at least a portion of reflected radiation in a digital frame;
computation means to
   identify said reflected said vertices and rectilinear segments in said radiation pattern;
   obtain 3-D coordinates by triangulating said interconnected rectilinear segments;

An apparatus configured to obtain 3-D spatial coordinate of a moving 3-D scene.

An apparatus further configured to move in three-dimensions in relation to the 3-D scene;

### BRIEF DESCRIPTION OF THE DRAWINGS

With specific reference to the drawings the particulars are described to provide useful and readily understanding of principles and conceptual aspects of present invention, such that taken with the description is making apparent to those skilled in the art how the invention may be embodied into practice.

FIG. 1 is a schematic diagram illustrating one embodiment of the present invention showing how bi-dimensional light pattern is utilized together with various means to obtain three-dimensional coordinates of imaged object.

FIG. 2 is a simplified depiction illustrating reference images formation and schematic representation of reflected pattern in accordance to embodiments of present invention.

FIG. 3 is a representation of bi-dimensional pattern and bi-dimensional pattern reflection from a 3-D object depicting identification of two-dimensional nodes on a reference pattern image in accordance to epipolar principles.

FIG. 4 contains simplified representation of bi-dimensional pattern having some transparent lattice loops in accordance to epipolar depth.

### DETAILED DESCRIPTION

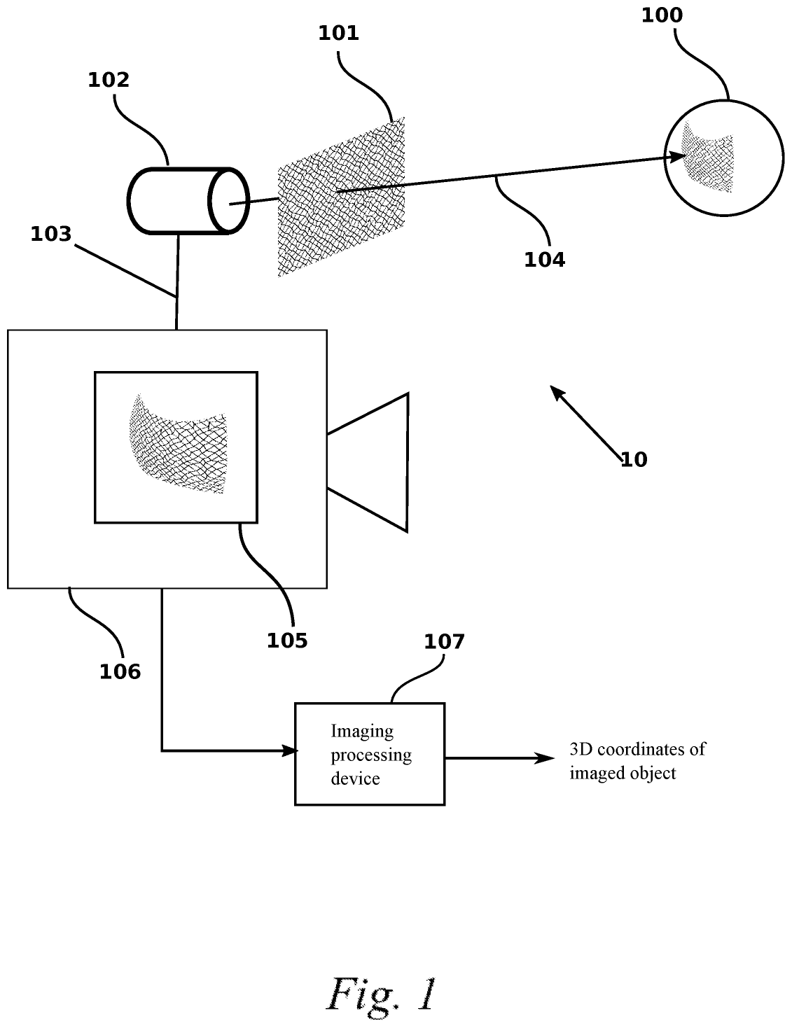

FIG. 1 is a simplified representation of the principle of the preferred embodiment of present invention. In particular the system 10 comprises projector 102, image sensor 106 and computation means 107. Projector 102 emits electromagnetic radiation represented by ray 104. A bi-dimensional pattern 101 comprising a lattice of rectilinear segments forming irregular polygonal eyelets, is projected onto three-dimensional object 100. The pattern 101 is in the form of at least one transparency or in the form of at least one diffractive optical element (DOE) configured in accordance to projector 102. Electromagnetic radiation is generated by at least one pattern projector 110 illuminating pattern 101. Projector 110 could be in the form of surface-emitting laser arrays (VCSEL), resonant cavity light emitting diode arrays (RC-LED) or wavelength limited LED.

Radiation 104 illuminates at least a portion of object 100 under computer 107 control and electronic coupling 103. At least a portion of the radiation reflected form object 100 is recorded by image sensor 106 under computer 107 control and stored in digital frame 105 in the form of curvilinear formations of high-intensity pixels.

Pixels in the frame 105 are detected and analyzed by computer 107 utilizing imaging processing means to identify respective rectilinear segments in projected bi-dimensional pattern 101 corresponding to curvilinear formations. Computer 107 outputs 3D coordinates of illuminated object 100 by triangulating corresponding bi-dimensional pattern rectilinear segments and imaged curvilinear segments localized in digital frame 105.

In some embodiments projector 102 comprise multiple laser arrays elements are combined to illuminate certain portions of pattern 101 in different portions of the scene or project sequences of shifted versions to enable higher scene sampling.

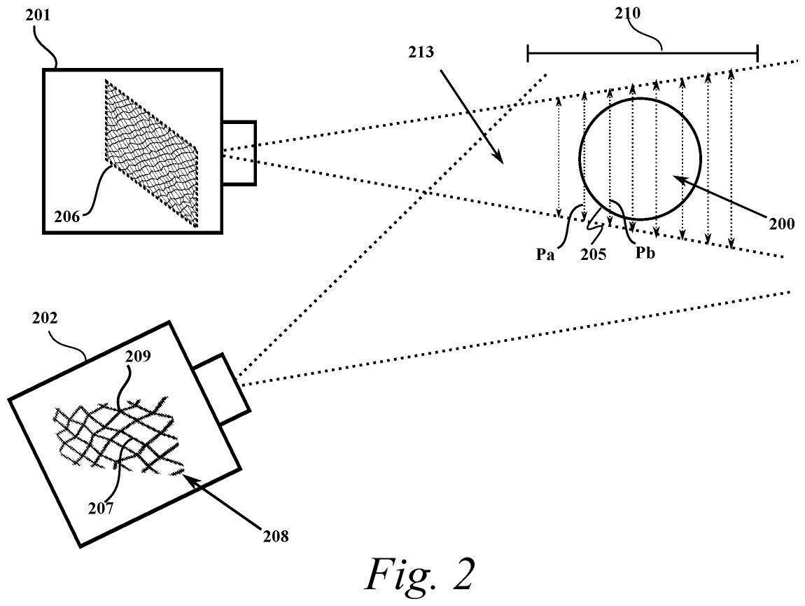

FIG. 2 is a schematic representation of image formation of the object 200 encoded by projection of pattern 206 by projector 201, having a depth of field 210, and recorded by image sensor 202 in digital frame 208.

Digital image recorded at digital frame 208 can be construed as combining virtual light sections effected by pattern 206 on object 200, when observed from perspective of image sensor 202. For example, rays reflected by perspective transformed pattern at section plane Pa, inside range 210, correspond to a first sub-set of pixels in frame 208 and belong to a sub-set of curvilinear segments in frame 208. Consequently, the depth of contributed pixels have the depth of Pa.

Section plane Pb, at an adjacent predetermined distance from Pa, correspond to a second sub-set of pixels in 208 distinct from subset contributed by Pa and also lie on a subset curvilinear segments in frame 208.

The first and second sub-set of pixels are pinpointed by correlating image in frame 208 to back-projected versions of the pattern in Pa and Pb positions in camera 202 frame.
To distinguish the pixels that belong to Pa and Pb depths, correlation is conducted step-wise across entire depth of field 210. Because polygonal structure is pseudo-random, pixels at Pa depth and pixels at Pb depth lay on same curvilinear segment in frame 208. For example at least some of pixels representing consecutive depths in range 205 can belong to curvilinear segment 207.

Because of pseudo-random polygonal structure other curvilinear segments may correlate to calculated pattern. However, only consecutive correlations on same curvilinear segment are validated and assigned depth at each pixel position.

In at least one embodiment, polygonal vertices are identified in projected bi-dimensional pattern by correlating pixels in frame 208 to versions of perspective transformed pattern in 210 reprojected to image sensor 202 viewpoint. The correlation is carried out over a subset of perspective transformed patterns having polygonal vertices on corresponding epipolar line. For example, to identify polygonal vertex 209 incremental correlation is carried out on perspective transformed patterns that include polygonal vertex on epipolar line corresponding to vertex 209.

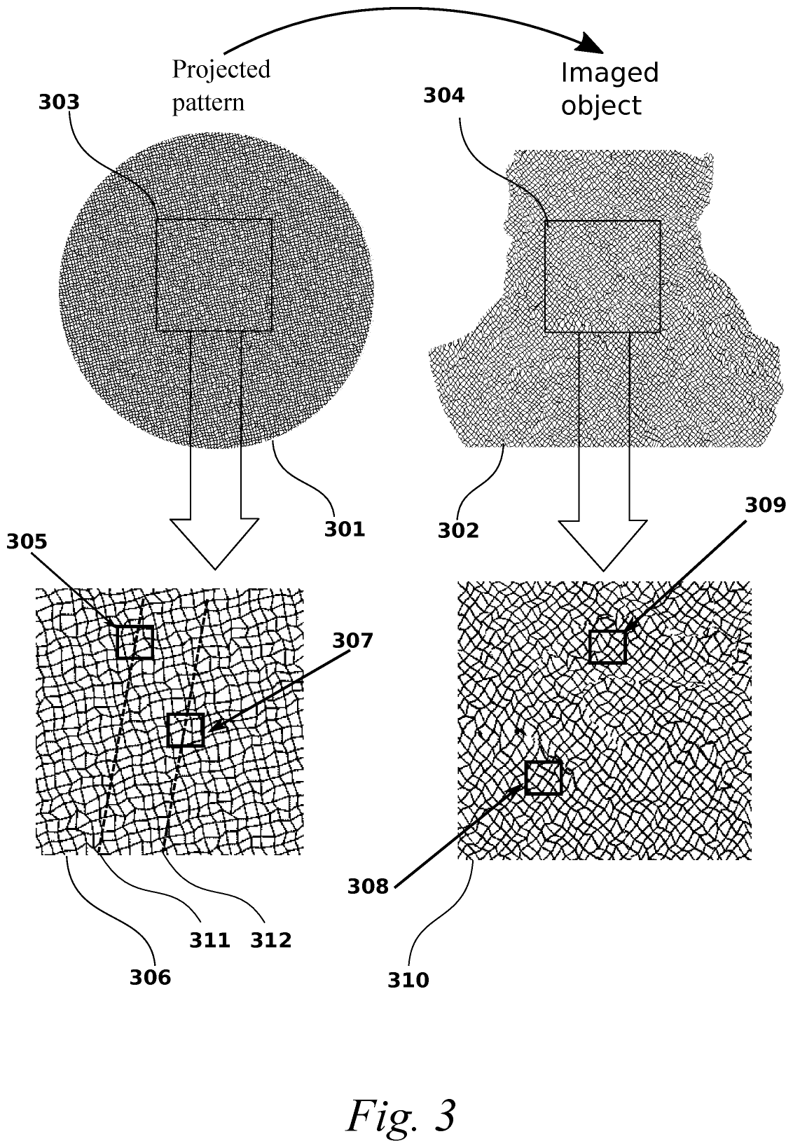

FIG. 3 depicts schematically the process of vertices identification in imaged object 302. Search is confined to region 303 corresponding to imaged object region 304. Magnified versions of region 304 and 303 are represented in 310 and 306 respectively. A search window of predetermined size 308 is centered around a vertex having corresponding epipolar line 311 in 306. Correlation of window 308 is advantageously conducted at vertices positions in 306 that belong to epipolar line 311. Similarly, window 309, centered around another vertex in 310 and having a corresponding epipolar line 312, is identified by correlation to window 307 in 306, carried out at vertices laying on 312, utilizing the process from FIG. 2.

It will be apparent for the skilled in the art that multiple vertices are identified inside each window 308, 309. It will also be apparent for the skilled in the art that correlation windows may overlap such that at least a subset of vertices are identified multiple times. Validation is carried out by results consistency at overlapping location.

One advantage of the method of current invention is ability to determine local surface orientation at each vertex because distinguishable curvilinear segments around the vertex and identified lattice linear segments give rise to intersecting three-dimensional planes, where intersecting line segment are tangent at the vertex.

It is in the spirit of this invention that correlation computation for the purpose of vertices identification can be substituted by other techniques known in the art such as neural network search techniques, and are therefore part of this invention.

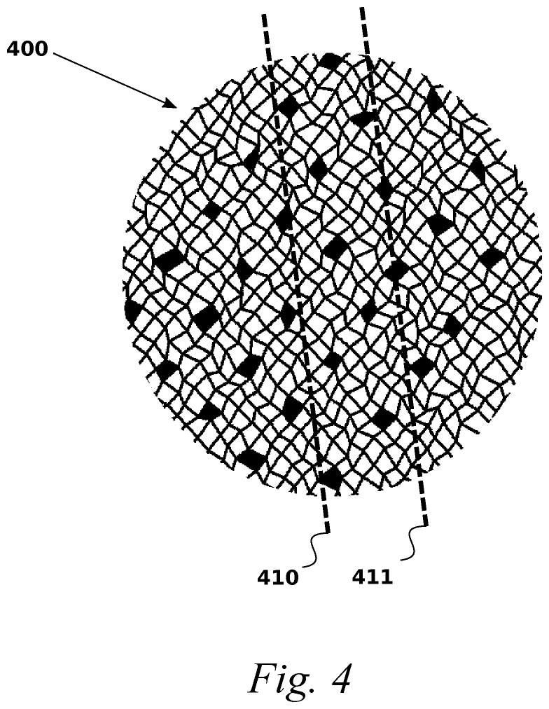

In another embodiment vertices identification is sped up utilizing a modified bi-dimensional pattern 400, schematically represented in FIG. 4, having a predetermined number of polygons transparent to projected radiations, where at least a portion of transparent polygons appear in digital frame 208 as distinctive filled regions. Pattern 400 is designed such that epipolar lines share a minimal number of filled polygons. That way correlation is carried out at a smaller number of locations on respective epipolar lines, as such reducing the number of computations necessary to identify vertices of filled polygonal eyelets. Moreover, identification of neighboring vertices is also simplified because a smaller number of epipolar locations need to be correlated. Those skilled in the art will realize that the size of search neighborhood around filled polygonal eyelets is dependent of epipolar travel and therefore dependent of geometry of the setup.

1. A method of obtaining three-dimensional (3D) coordinates of physical scenes comprising steps of:
(a) illuminating the a scene by at least one radiation pattern emanating from a projector frame, having a predetermined number of interconnected rectilinear distinguishable strips having non-regular and non-overlapping reticular configuration having distinguishable two-dimensional (2D) pixel formation at connecting vertices positioned at predetermined coordinates;
(b) recording at least a portion of said rectilinear strip configured in said polygonal formations in at least one digital frame in the form of profiles of illuminated pixels corresponding to said at least a portion of said rectilinear strips;
(c) locating said at least a portion of said polygonal formations in at least said digital frame;
(d) identifying at least a subset of said distinguishable 2D pixel formations at said connecting vertices in said at least one digital frame, to corresponding vertices in said radiation pattern, and
(e) identifying at least a subset of said illuminated profiles of pixels in said at least one digital frame to corresponding said interconnected rectilinear distinguishable strips in said radiation pattern;
(f) calculating 3D coordinates corresponding by triangulating said illuminated pixels in said subset of profiles in said digital frame and said identified subset of said interconnected strips in said radiation pattern with sub pixel precision.

2. A digitization system comprising:
(a) at least one projection assembly configured to emanate at least one radiation pattern onto a scene, wherein said pattern comprises a predetermined number of interconnected rectilinear distinguishable strips, wherein said strips have non-regular non-overlapping reticular configuration, wherein said strips have distinguishable two-dimensional (2D) pixel formations at connecting vertices, wherein said connecting vertices have predetermined coordinates;
(b) at least one image capture assembly configured to capture radiation reflected from said scene in at least one digital frame, wherein said digital frame comprises at least some of said rectilinear distinguishable strips and connecting vertices in form of profiles of illuminated pixels and some of said connecting vertices in form of illuminated pixel groupings;
(c) at least one computing unit configured to:
(i) determine location at least a subset of said profiles of illuminated pixels and said illuminated pixel groupings;
(ii) identify at least a subset of said illuminated pixel grouping in said digital frame by corresponding connecting vertices in radiation pattern;
(iii) identify at least a subset of said at least some of said profiles in said at least one digital frame by corresponding said strips in said radiation pattern;
(iv) calculate 3D coordinates of said at least a subset of said profiles in said at least one digital frame with sub pixel precision.
